(19) United States
(12) Patent Application Publication
(10) Pub. No.: US 2004/0225542 A1
(43) Pub. Date: Nov. 11, 2004

(54) System and method for arranging group travel

(76) Inventors: Charles Whiteman, (US); Kevin Senecal, (US)

Correspondence Address: ARTZ & ARTZ, P.C., 28333 TELEGRAPH RD., SUITE 250, SOUTHFIELD, MI, 48034, US

(21) Appl. No.: 10/752,922

(22) Filed: Jan. 7, 2004

Related U.S. Application Data
(60) Provisional application No. 60/460,533, filed on Apr. 4, 2003.

(51) Int. Cl. G06F 17/60

(52) U.S. Cl. 705/7

(57) ABSTRACT

A system and method for arranging travel includes receiving travel information from a several consumers and grouping them according to common travel requirements, contacting several service providers, and negotiating a group discount with at least one service provider as a function of the grouping. The system and method further includes booking the grouping with the service provider.

### TECHNICAL FIELD

The present invention relates generally to on-line transactions, and, more particularly, a system and method for providing group travel arrangements.

### BACKGROUND

Reducing consumer costs is a constant goal for current systems that have been developed for the general purpose of planning and arranging travel, i.e. travel arrangement systems. In particular, travel arrangement systems have involved the use of computer databases combined with software to find and determine the lowest fares available for airlines, resort locations, and various other travel accommodations and activities.

There have been many systems designed to aid, in a limited way, in the planning and execution of travel arrangements. For many years, travel arrangements have been made for consumers by travel agencies having standalone systems, with electronic or simple telephonic links to travel providers such as airlines, passenger trains, buses, car rental agencies and the like, and links to travel related service providers, such as hotels, restaurants, entertainment facilities, etc. In effect, the consumer relied on the travel agency to locate the best available fares and rates.

In recent years, consumers have gained greater direct access to information related to travel service providers via the internet. Such information includes airline schedules, flight availability, hotel locations, and entertainment location information. In order to reserve a seat on a plane or a hotel room, the individual must still make separate contact with a particular provider and make the reservation based upon the provider's distinct reservation system. This can often be a time consuming process, whereby the best possible rate for travel and travel-related activities may not be obtained. In other words, although inexpensive fares may be available, the consumer must go through a considerable search process in order to gather information regarding travel and travel-related activities.

This search process may include bidding on websites such as priceline.com®, wherein the consumer attempts to bid for the lowest price acceptable to a service provider. This process, however, requires the consumer to guess at what the current low rate is and may thus not necessarily end up reducing cost to the consumer.

The disadvantages associated with current, methods applied by consumers for making travel arrangements have made it apparent that a new technique for arranging travel is needed. The new technique should rapidly and efficiently locate the least cost travel arrangements. The new technique should also minimize the time consumers spend searching for cheapest fares. The present invention is directed to these ends.

### SUMMARY OF THE INVENTION

In accordance with one aspect of the present invention, a travel arrangement system for a plurality of consumers includes a database storing information regarding multiple groups of the plurality of consumers. The database includes at least one common consumer preference parameter per group. The system further includes a database processor generating the database as a function of a plurality of consumer preference parameters including the at least one common consumer preference parameter. The system still further includes an agent negotiating a discount rate from a travel service provider for one of the set of groups.

In accordance with another aspect of the present invention, a method for arranging travel includes receiving travel information from a plurality of consumers, generating a grouping of consumers having common travel requirements as a subset of the plurality of consumers, contacting at least one service provider, and negotiating a group discount with the at least one service provider as a function of the grouping. The method further includes substituting a SCUBA related activity for cost savings associated with the group discount, generating an individualized SCUBA information profile for at least one member of the grouping of consumers, and booking the grouping with the at least one service provider.

Additional advantages and features of the present invention will become apparent from the description that follows and may be realized by the instrumentalities and combinations particularly pointed out in the appending claims, taken in conjunction with the accompanying drawings.

### BRIEF DESCRIPTION OF THE DRAWINGS

For a more complete understanding of the invention, there will now be described some embodiments thereof, given by way of example, reference being made to the accompanying drawings, in which:

FIG. 1 is a block diagram of a system for making travel arrangements in accordance with one embodiment of the present invention;

FIG. 2 is a logic flow diagram of a method for SCUBA certification in accordance with another embodiment of the present invention; and

FIG. 3 is a logic flow diagram of a method for making travel arrangements in accordance with another embodiment of the present invention.

### DETAILED DESCRIPTION OF THE PREFERRED EMBODIMENT

The present invention is illustrated with respect to a system and method for making travel arrangements, particularly suited to web browsing and database storage applications. The present invention is, however, applicable to various other uses that may require economical application of consumer data, as well be understood by persons skilled in the art.

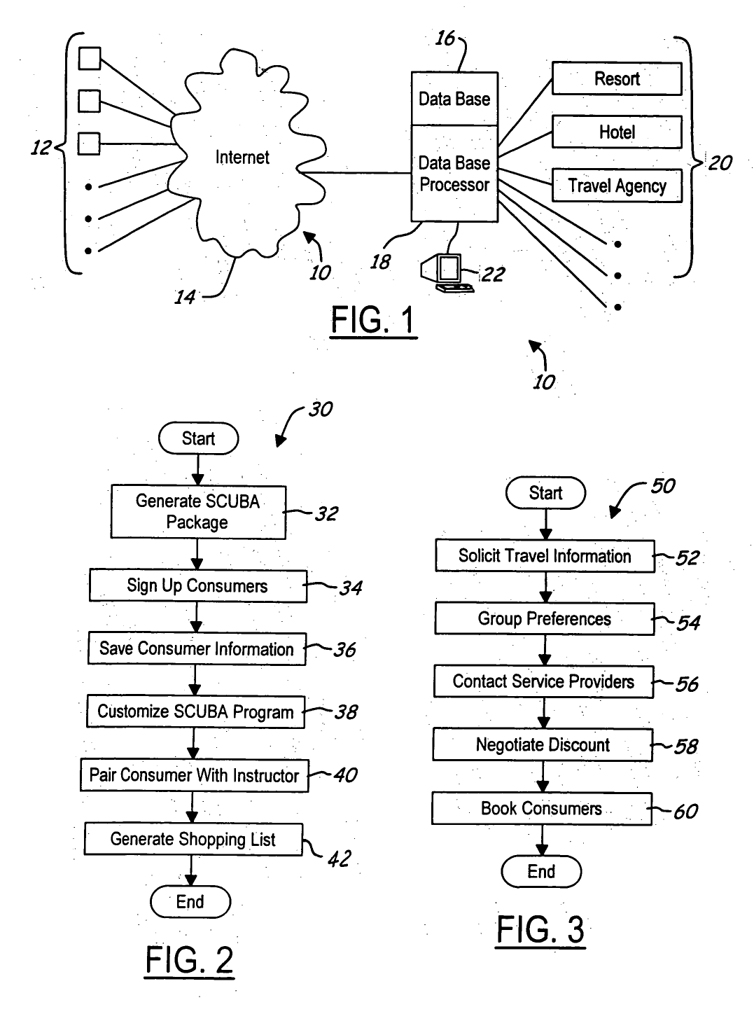

Referring to FIG. 1, a block diagram of a system 10 for making travel arrangements, in accordance with one embodiment of the present invention, is illustrated. The system 10 includes a plurality of consumers 12, an information medium 14 (internet), a database 16, a database processor 18, and a plurality of service providers 20.

The plurality of consumers 12 send information to and receive information from the information transfer medium 14. The information transfer medium 14 is coupled to the database processor 18, which is coupled to the database 16. The database 16 and database processor 18 receive information from the plurality of service providers 20.

In accordance with one embodiment of the present invention, the database 16 and the database processor 18 (or the travel agency operating the database 16) receive travel information from the plurality of consumers 12 and group this information into requirements and preferences including, for example, “individuals interested in the same trip.”

Once a certain number of people meet a selected criterion, they are contacted and a trip is proposed to them. The database processor 18 or travel agency then contacts the plurality of service providers 20, negotiates group rates or group discounts on behalf of the plurality of consumers 12, confirms interest in booking, and books the plurality of consumers on the trip (e.g. a SCUBA trip) for the negotiated-price.

The consumers 12 are embodied herein as individuals operating respective computer terminals seeking information from an information source, embodied herein as the information transfer medium 14 or the internet. Alternately, individuals receive solicitations from a travel agency or travel agent 30 managing the database 16 and the database processor 18. Instead of a travel agency, the solicitations can occur for a company that sponsors trips or outings, such as SCUBA vacations.

The database 16 includes information relating to various common parameters (consumer preference parameters) that consumers 12 may desire when seeking travel arrangements. An example of parameters included herein are as follows:

*Required

1.* Name

2.* Daytime Phone

3. Evening Phone

4. Email

5. Number of adult travelers

6. Number of children under 12 traveling

7. (Y If Y, goto) I know exactly where I want to go (skip ahead). (Y) I would like to answer a few questions to identify several destinations that would be a good fit for me.

8. (A, R, E, T) Designing your next vacation is a lot like decorating your living room. There are many ways to make it look good, but the perfect design reflects your personal style and the mood you're trying to create. Please review this diagram and select the style of vacation that you're looking for.

9. Your prioritization of the things you'd like to do on your next vacation will help us to suggest those destinations and resorts that are most likely to make you happy. Note: Only prioritize those activities that are important to you (if it doesn't matter, leave it blank).

Beach

Children's Activities

Dining

Diving

Fishing

Golf

Hiking

Kayaking

Massage/Spa

Nightlife/Entertainment

Parasailing

Sailing

Sightseeing

Snorkeling

Socializing

Tennis

Waterskiing/wakeboarding

Windsurfing

Whale Watching

10. You said that diving was important to you. Please rank the types of diving you'd like to experience below:

Advanced Diving

Beginner Diving

Big Animal Encounters

Cave/Cavern Diving

Dolphin Encounters

Live aboard Diving

Macro Photography

Shark Encounters

Shore Diving

Wall Diving

Wreck Diving

11. A resort's amenities can be a determinant of your enjoyment. Please rank any amenities that are important to you.

Bar (on-site)

Daily Laundry Service

Kitchen/Kitchenette

Pool

Restaurant (on-site)

12. (Budget, Moderate) Please select the class of accommodations you would prefer.

13. Please identify the dates and times you are available so that we can search to find the best deal for you.

14. Please select the number of nights you would like to spend on vacation. If you would like us to consider varying durations, prioritize the number of nights in descending order of preference.

15. Based on your answers, we have prioritized the resorts we offer in descending order of relevance to you and your travel preferences. Please rank these resorts in order of your preference. Leave those that you are not interested in unranked.

16. Would you like us to quote air (separately) for you?

17. Departing city?

Departure time of day?

Returning city?

Returning time of day?

The consumers 12 may alternately fill out the database information directly by logging onto an internet site, or by responding to solicitations made from the database processor 18 or a travel agent service operating the database 16 and database processor 18.

The database processor 18 is embodied as a host server receiving information from the consumers 12 through the information transfer medium 14, storing that information in the database 16, analyzing the database information and contacting and negotiating with service providers such as: resorts, hotels, travel agencies, SCUBA certification agencies, etc. Alternate embodiments of the database processor include a database operator engaging all the database processor functions rather than having an independent database processor 18 conducting negotiations and soliciting the consumers 12.

Examples of functions engaged by the database processor 18 include the arrangement of travel services. The database processor 18, or alternately a travel service provider, solicits travel requirements (i.e., dates, times, price range, etc.) and preferences (i.e., destinations, accommodations, amenities, excursions, etc.) of a large population of consumers. The database processor 18 groups the aforementioned requirements and preferences into collections of individuals that are interested in the same trip or activity. The database processor 18 contacts the service provider 20 for various groupings of commonly sought trips or activities.

The database processor 18 or a travel agent service operator 22 then negotiates a group discount on behalf of the consumers having common interests, or alternately chooses specific resorts having group travel incentives. The database processor 18 or travel agent service operator 22 contacts the interested consumers with the negotiated or predetermined rate and books them for a trip having a price lower than a retail price.

The database processor 18, in another embodiment of the present invention, rather than offering the consumers 12 a discounted rate, provides consumers with a comparable market rate, however, through the savings generated in the negotiated group rates, may automatically include an additional desirable service. Alternately, the database processor 18 may offer consumers 12 a discounted rate in conjunction with the additional desirable service.

Referring to FIG. 2, an example of a desirable service including SCUBA diving, SCUBA diving certification, and SCUBA diving equipment, is illustrated in a logic flow diagram 30.

The SCUBA service is generated on-line, and steps therefor are hereinafter discussed. Logic in FIG. 2 starts in operation block 32 when the system 10 or travel agent service generates packages including such services as SCUBA for a plurality of consumers 12 desiring a specific travel destination. The database processor 18 then generates various services automatically or in response to consumer requests for specific services.

In other words, in operation block 34, the consumers 12 may be automatically signed up for an online SCUBA certification program. The results or inputs of which, in operation block 36, are saved in the database 16 and provided to a SCUBA instructor at the site of their vacation.

In operation block 38, the content of the SCUBA certification program is automatically customized to the group of individuals choosing the specific resort. The information is further customized to that resort and waters nearby, wherein the consumers will engage in SCUBA diving.

Resultantly, in operation block 40, when consumers 12 arrive at the destination or resort, they may be paired with specially trained instructors who review their tests and academic results, thereby providing a productive SCUBA training scheme for the consumers based on level of skill.

In operation block 42, an automatic shopping list of SCUBA gear will also be provided as a recommendation for consumers choosing a specific destination. The shopping list is filled automatically through information in the database 16 including, for example, customer approval and credit card number.

Resultantly, the system 10 may obtain group discounts on SCUBA rentals, SCUBA gear purchases, and instructor time.

Generally the database processor 18 or travel agent service operator markets either resort destinations or resort destinations in tandem with a specific service such as SCUBA. The marketing is automatically generated through the database processor 18 or alternately through mass mailings or publications in newspapers or periodicals, or through internet websites, or CD ROMs or DVDs included in magazines.

Referring to FIG. 3, a logic flow diagram 50 of a system, in accordance with one embodiment of the present invention, is illustrated. Logic starts in operation block 52, where either a database operator or the database processor 18 receives consumer preference information in response to solicitations or consumer inquires.

In operation block 54, the database processor 18 groups consumers having common consumer preferences.

In operation block 56, either the database processor 18 or the travel agency operating the database 16 contact several service providers.

In operation block 58, either the database processor 18 or the travel agency operating the database 16 negotiate a discount with at least one of the travel service providers. This discount is then either applied directly to the group or redirected to offset costs of other activities desired by members of the group, such as SCUBA related activities. Important to note is that the discounts may be on a group basis, for example, the database processor 18 will guarantee a number of spots for a high enough rate promised by the consumer 12.

In operation block 60, either the database processor 18 or the travel agency operating the database 16 books the consumers into a vacation package.

In operation, a method for arranging travel includes receiving travel information from a plurality of consumers, generating a grouping of consumers having common travel requirements as a subset of the plurality of consumers, contacting at least one service provider, and negotiating a group discount with the at least one service provider as a function of the grouping. The method further includes substituting a SCUBA related activity for cost savings associated with the group discount, generating an individualized SCUBA information profile for at least one member of the grouping of consumers, and booking the grouping with the at least one service provider.

From the foregoing, it can be seen that there has been brought to the art a new and improved system and method for making travel arrangements. It is to be understood that the preceding description of the preferred embodiment is merely illustrative of some of the many preferred embodiments that represent applications of the principals of the present invention. Numerous and other arrangements would be evident to those skilled in the art without departing from the scope of the invention as defined by the following claims.

What is claimed is:

1. A travel arrangement system for a plurality of consumers comprising:
a database storing information regarding a set of groups comprising the plurality of consumers having at least one common consumer preference parameter per group;
a database processor generating said database as a function of a plurality of consumer preference parameters comprising said at least one common consumer preference parameter; and
a travel agent negotiating a discount rate from a travel service provider for one of said set of groups.

2. The system of claim 1, wherein said database processor determines a lowest cost travel service from a plurality of travel service providers and wherein said database books at least one of said multiple groups of the plurality of consumers into a travel package.

3. The system of claim 1, wherein at least one of said multiple groups of the plurality of consumers is booked into a travel package, and wherein said database processor substitutes an alternate service for at least a portion of a cost saving generated from group booking through a travel service provider.

4. The system of claim 3, wherein said alternate service comprises SCUBA related activities or equipment.

5. The system of claim 4, wherein said database processor receives SCUBA certification and consumer requirement information for said SCUBA related activities and stores said SCUBA certification and consumer requirement information in said database, wherein said database processor generates at least one individualized shopping list of needed SCUBA gear for one or more members of said at least one of said multiple groups of the plurality of consumers.

6. The system of claim 5, wherein said individualized shopping list is filled out automatically as a function of said consumer requirement information.

7. A method for arranging travel comprising:
receiving travel information from a plurality of consumers;
generating a grouping of consumers having common travel requirements;
contacting at least one service provider; and
negotiating a group discount with said at least one service provider as a function of said grouping.

8. The method of claim 7 further comprising: soliciting said travel information from said plurality of consumers.

9. The method of claim 7 further comprising: generating a plurality of groupings of consumers having common travel requirements.

10. The method of claim 7 further comprising: contacting a plurality of service providers; negotiating group discounts from said plurality of service providers; and determining which of said plurality of service providers offers a lowest rate.

11. The method of claim 7 further comprising: booking said grouping of consumers into a travel package as a function of said group discount.

12. The method of claim 11 further comprising: substituting an alternate service for said group discount.

13. The method of claim 12, wherein substituting further comprises generating a package comprising SCUBA related activities or equipment.

14. The method of claim 13 further comprising: automatically signing said grouping of consumers in a SCUBA certification program; storing results of said SCUBA certification program; and generating individual consumer SCUBA information for use by SCUBA instructors at a travel destination included within said travel package.

15. The method of claim 12 further comprising: marketing said alternate service in tandem with said travel package.

16. A method for arranging travel comprising:
receiving travel information from a plurality of consumers;
generating a grouping of consumers having common travel requirements as a subset of said plurality of consumers;
contacting at least one service provider;
negotiating a group discount with said at least one service provider as a function of said grouping;
substituting a SCUBA related activity for cost savings associated with said group discount;
generating an individualized SCUBA information profile for at least one member of said grouping of consumers; and
booking said grouping with said at least one service provider.

17. The method of claim 16 soliciting said travel information from said plurality of consumers through an internet or mass mailing system.

18. The method of claim 16 further comprising: contacting a plurality of service providers; negotiating group discounts from said plurality of service providers; and determining which of said plurality of service providers offers a lowest rate.

19. The method of claim 16 further comprising: pairing said at least one member with a SCUBA instructor, wherein said SCUBA instructor receives said individualized SCUBA information profile.

20. The method of claim 16, wherein generating said individualized SCUBA information profile further comprises training said at least one member on-line; and testing said at least one member on-line.
